(19) United States
(12) Patent Application Publication
(10) Pub. No.: US 2008/0104510 A1
(43) Pub. Date: May 1, 2008

(54) Graphical Interface for Search Engine

(75) Inventor: Charles A. Eldering, Furlong, PA (US)

Correspondence Address: TECHNOLOGY, PATENTS AND LICENSING, INC., 2003 South EASTON ROAD, SUITE 208, DOYLESTOWN, PA, 18901, US

(73) Assignee: Graphwise, LLC

(21) Appl. No.: 11/924,632

(22) Filed: Oct. 26, 2007

Related U.S. Application Data
(60) Provisional application No. 60/854,894, filed on Oct. 27, 2006.

(51) Int. Cl. G06F 3/00

(52) U.S. Cl. 715/700

(57) ABSTRACT

The invention relates to presenting search query results to a user in a manner that displays hits organized by categories, thereby presenting the user with the ability to view the number of hits in a particular category and to then link to those individual hits. The invention includes various types of displays to include those which incorporate time criteria to thereby provide the user with additional useful information in a user friendly manner.

### CROSS REFERENCE TO RELATED APPLICATION

This application claims the benefit of U.S. Provisional Patent Application No. 60/854,894, filed Oct. 27, 2006, and entitled Graphical Interface for Search Engine, the entire disclosure of which is incorporated herein by reference.

### COPYRIGHT NOTICE AND AUTHORIZATION

Portions of the documentation in this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BRIEF DESCRIPTION OF THE DRAWINGS

The following detailed description will be better understood when read in conjunction with the appended drawings, in which there is shown one or more of the multiple embodiments of the present invention. It should be understood, however, that the various embodiments of the present invention are not limited to the precise arrangements and instrumentalities shown in the drawings.

In the Drawings:

FIG. 1 is a use case diagram for a graphical search engine according to one embodiment of the invention;

FIGS. 2A-2E depict performing exemplary Blog searches and displaying resulting data to a user according to various embodiments of the invention;

FIGS. 3A and B depict performing an exemplary Catalog search and displaying resulting data to a user according to an embodiment of the invention;

FIGS. 4A and B depict performing an exemplary Game search and displaying resulting data to a user according to an embodiment of the invention;

FIG. 5 is a class diagram for the graphical search engine of an embodiment of the present invention; and

FIG. 6 depicts various embodiments of the invention in which hardware and its corresponding functionality is deployed in a network configuration.

### DETAILED DESCRIPTION

The following detailed description will be better understood when read in conjunction with the appended drawings, in which there is shown one or more of the multiple embodiments of the present invention. It should be understood, however, that the various embodiments of the present invention are not limited to the precise arrangements and instrumentalities shown in the drawings. The words “right”, “left”, “lower” and “upper” designate directions in the drawings to which reference is made.

Certain terminology is used herein for convenience only and is not to be taken as a limitation on the embodiments of the present invention. In the drawings, the same reference letters are employed for designating the same elements throughout the several figures.

Unified Modeling Language (“UML”) can be used to model and/or describe methods and systems and provide the basis for better understanding their functionality and internal operation as well as describing interfaces with external components, systems and people using standardized notation. When used herein, UML diagrams including, but not limited to, use case diagrams, class diagrams and activity diagrams, are meant to serve as an aid in describing the embodiments of the present invention, but do not constrain implementation thereof to any particular hardware or software embodiments. Unless otherwise noted, the notation used with respect to the UML diagrams contained herein is consistent with the UML 2.0 specification or variants thereof and is understood by those skilled in the art.

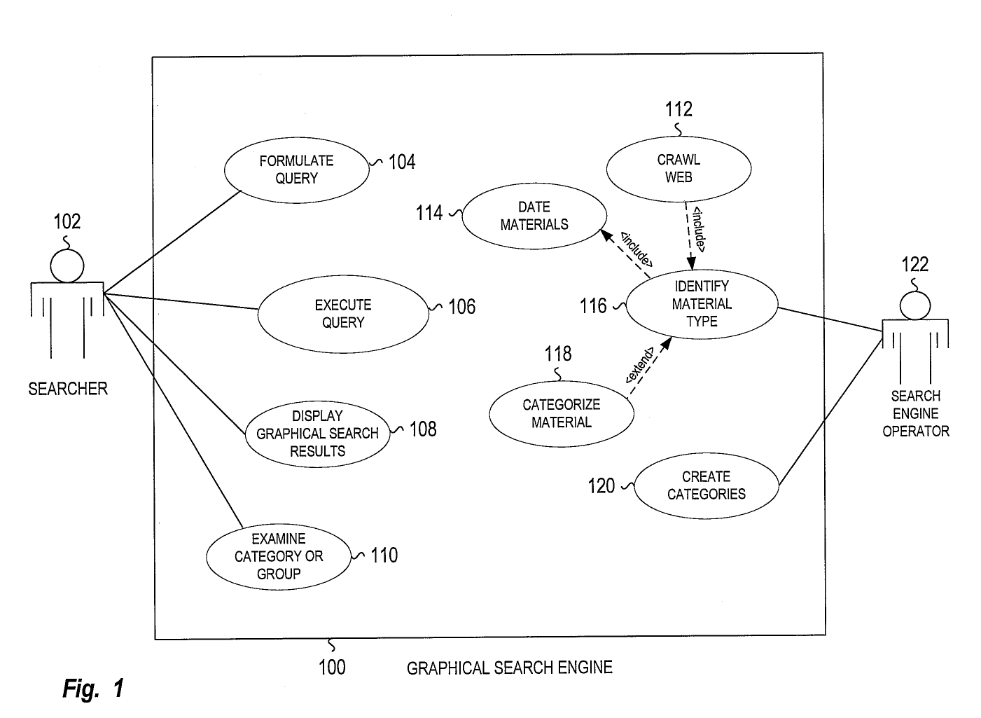

FIG. 1 is a use case diagram for a graphical search engine 100 that allows a search engine operator 122 to configure the system to both crawl the web and collect materials, as well as to identify, date, and categorize those materials. A searcher 102 (user) can formulate a query through a typical graphical user interface, execute the query, and receive the graphical results that have been displayed, those graphical results indicating the categories, as will be discussed below. The searcher can then request additional detail on a particular category or group and have that information subsequently displayed.

Referring to FIG. 1, the search engine operator 122 accesses the graphical search engine 100 and accesses a crawl web use case 112. The crawl web use case can include an identify material type use case 116, which in turn can include a date materials use case 114. A categorize material use case 118 can extend the identify material type use case 116. The search engine operator can also access a create categories use case 120. A searcher 102 (user) can access a formulate query use case 104 which allows the searcher to create the search and specify the search criteria, an execute query use case 106 can be accessed, a display graphical search results use case 108 can be accessed, and an examine category or group use case 110 can be invoked.

Search engines provide the user the ability to enter keywords and to receive what the search engine determines to be relevant information. This information is typically displayed on the screen in linear fashion, with items deemed most relevant being listed first, and with samples of the retrieved results being displayed along with the Uniform Resource Locator (URL) describing the source location. In some instances many pages of results are presented, requiring the user to examine the results of every page to view potentially useful hits.

Some search engines divide information into categories in order to facilitate searches within those categories. Users can either browse the categories or perform searches in those categories.

In order to facilitate the organization and presentation of search results which may cut across many categories, one embodiment of the present invention provides for the graphical presentation of the number of search results within a category, or from a particular site, and as such provides the user with the ability to view the number of hits in a particular category, or from a particular site, and to then go in to view those hits. This allows for a more rapid examination of results and access to the most appropriate search categories. This technique can be applied to a number of search categories as well as searches directed at specific types of content such as blogs, catalogs, images, audio, and video.

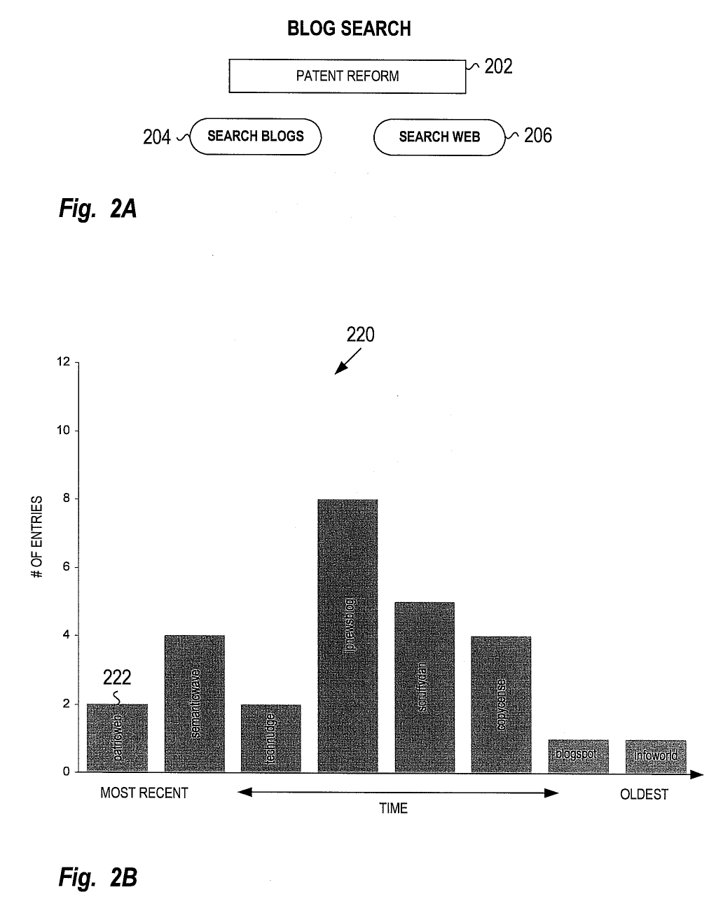

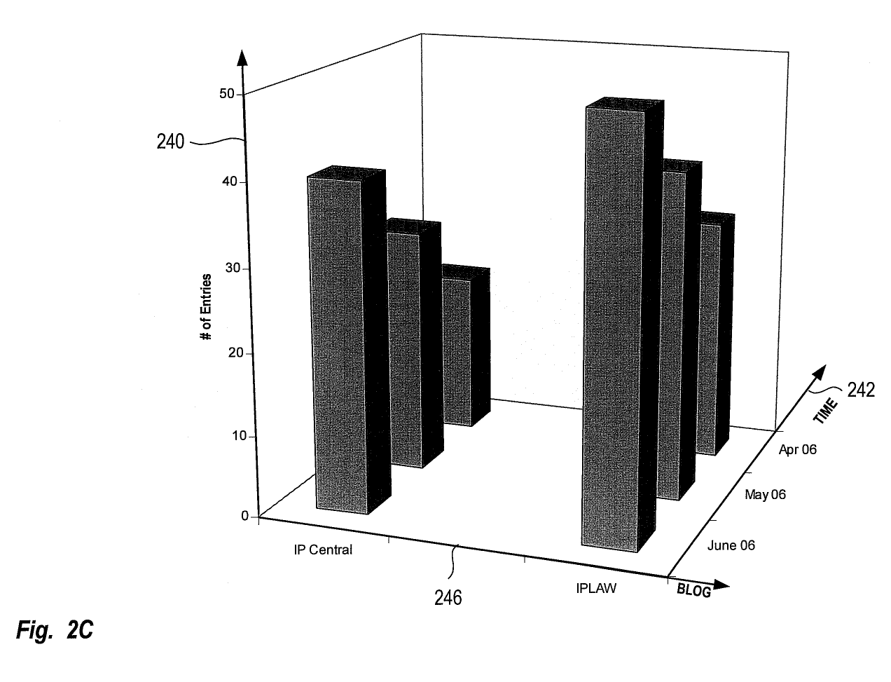

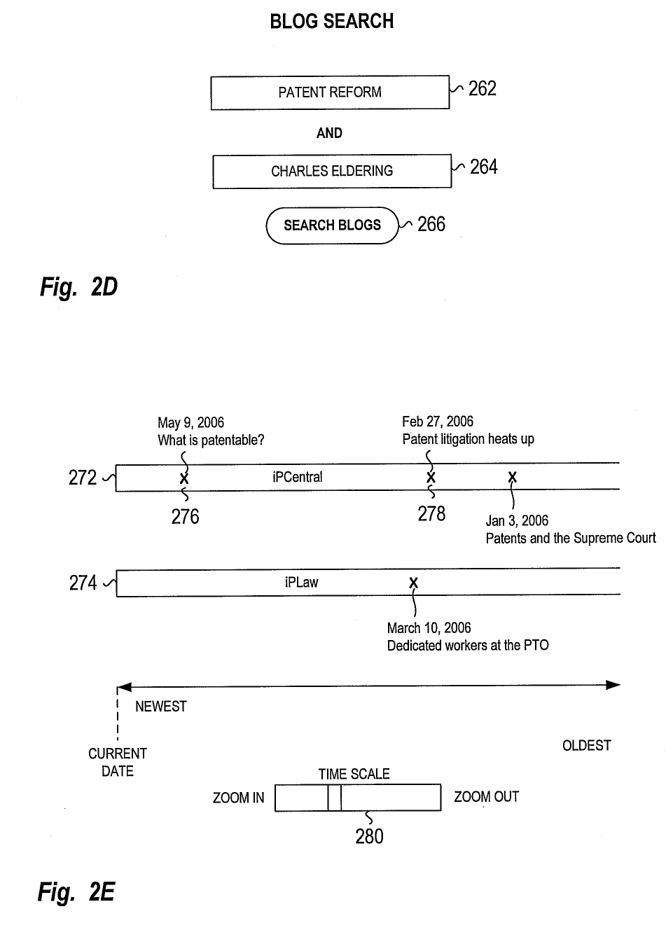

FIG. 2A shows an example of a blog search interface which supports queries of all known blogs (query to the blogosphere) and which returns the results in a graphical format. In particular, FIG. 2A illustrates how one or more search terms (e.g. “patent reform” are entered into a text entry box 202. Radio buttons permit a user to select a blog search or a web search (items 204 and 206, respectively). One embodiment of a graphical format for depicting the results of an initial blog search is shown in FIG. 2B, with the blogs (identified by the unique portion of their domain name, such as “ipnewsblog”) shown, with blogs having the highest number of recent entries being placed to the left, and blogs having older entries being placed to the right. In further embodiments of the invention, “recent” is defined by a time window default setting and/or by a user selectable parameter (e.g. “within the last 30 days”). The number of entries on each blog can be seen by the height of the indicator bar 222 (or other indicator) on the graph 210. The user can choose to examine the results from any particular blog by clicking on that blog bar 222. In one embodiment the blog entries for that blog are then presented to the user as a linear listing of blog entries from that blog having the search keyword. In an alternate embodiment, the user accesses the blog directly from the graphically presented search result.

FIG. 2C illustrates a further embodiment of the invention which provides a three-dimensional presentation 240 of blog entries in which the third dimension is used as the time dimension 242. By utilizing a time dimension, additional time dependent information can be presented and the number of blog entries over time displayed. Additionally, the searcher may access a particular period of time (by clicking on that time bar or bin e.g., 246) and access those blog entries. Thus should a particular blog search indicate unusual activity (i.e., a high volume) of blogs occurring in a given time period, the displayed results will not only so indicate, but will readily permit a user to access these blogs to see what “all the excitement” was about. In one embodiment clicking on a time bar or bin leads to the display of entries for that time period. In another embodiment, clicking on a time bar or bin leads to a summary representation of those blog entries for that time period. In one embodiment that summary representation includes a graphical representation of the number of blog entries by site.

FIG. 2D shows an example of a blog search in which two text entry boxes 262 and 264 are provided to permit entry of two keywords or phrases to be used to search the blogosphere when the “Search Blogs” button 266 is activated. In one embodiment, such as that shown in FIG. 2E, the results are presented in a set of horizontal timelines (272 and 274), with each timeline representing a particular blog (ipCentral and iPlaw, respectively). In one embodiment, the blog entries matching the search criteria are marked with a graphical marker such as an X or other indicator (e.g., 276 and 278). In one embodiment, the user can place a cursor or marker over a particular entry, and have a portion or all of that blog entry appear in a box (not illustrated). This can be supported through RSS or other suitable technologies. A further embodiment of the invention, as shown in FIG. 2E, is the use of a timescale 280, which can be zoomed in or out to allow higher resolution of the graphically presented results.

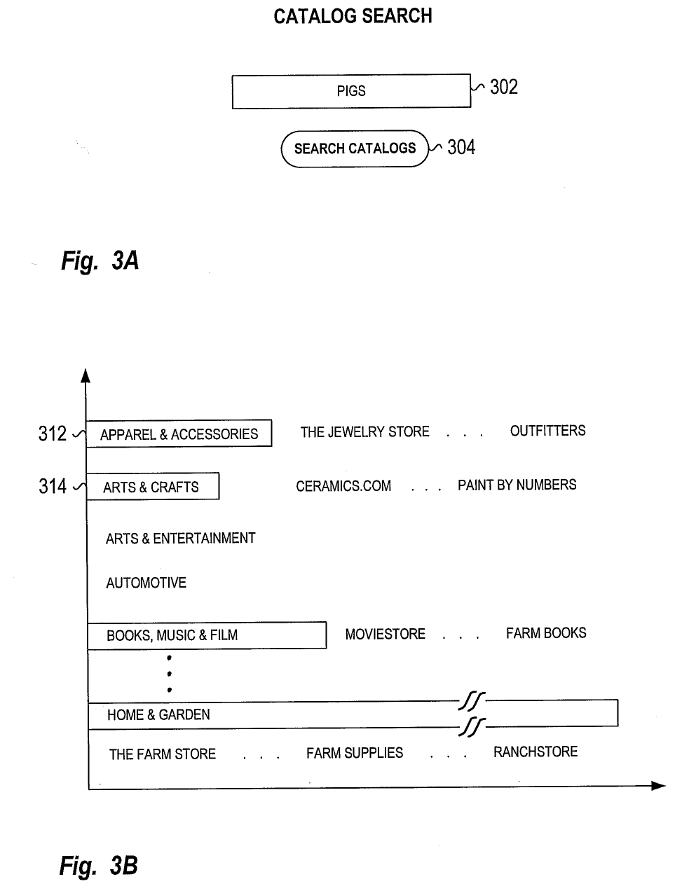

FIG. 3A shows an example of a catalog search query (the search term “pigs” having been entered in text box 302) which allows a user to search a collection of catalogs. In many search engines, a catalog search will produce a linear list of hits, without regard to any categories. In one embodiment of the present invention, as shown in FIG. 3B, the various categories of hits appear in horizontal bars (e.g., 312 and 314) with the number of hits in each category indicated by the horizontal length of each search bar result, and with the individual hits being listed in a horizontal manner to the right of the bar (e.g., “The Jewelry Store . . . Outfitters” appearing to the right of bar 312). Thus, the present invention permits a user to do a broad search (e.g., “pigs) and then displays the search results in a manner that enables him to then readily limit his search results by use of the depicted subcategories. Thus, as an example, a user can readily find sources of pig jewelry and perhaps at a local or familiar store (e.g., “Outfitters”) without having to scroll down a length list of hits or perform any express subsequent searches.

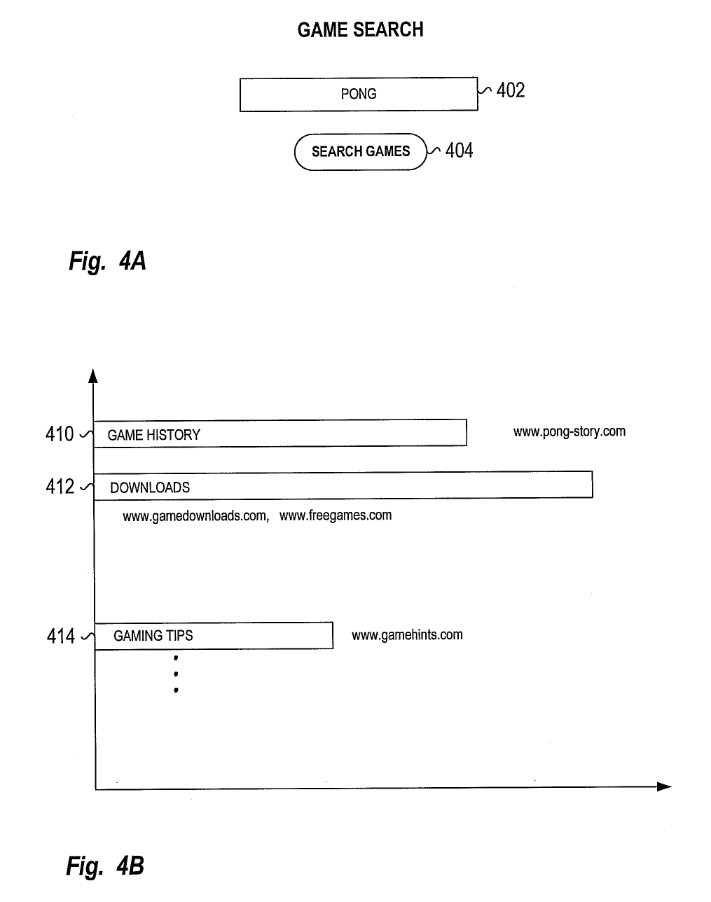

FIGS. 4A and 4B show an example of a query of the categories of games, with the results being presented as horizontal bars, the length of which is representative of the number of hits. In the embodiment show in FIGS. 4A and 4B a query for a particular game (“pong” having been entered in text window 402) within the general category of games returns an indication as to the number of hits within subcategories, which in the present example includes “Game History”, “Downloads” and “Gaming Tips” displayed in horizontal bars 410, 412 and 414, respectively). In one embodiment the specific sites are listed horizontally, with the sites believed to be most applicable being listed to the left. In an alternate embodiment the sites are listed vertically in a space to the right (or left) of the graphical display showing the number of hits within subcategories.

In one embodiment of the present method and system, the presentation technique is applied to desktop searches or the presentation of search results for materials such as e-mail. In this embodiment, the desktop can be searched for relevant materials, with the results being presented in a graphical format such that the user can simply click on a particular category to examine the search results in that category. In one embodiment, results of searches on e-mail can be presented in a graphical format, with the categories corresponding to sender, and the number of e-mails being represented over time when the graph is 3-dimensional, or simply tabulated when the graph is 2-dimensional.

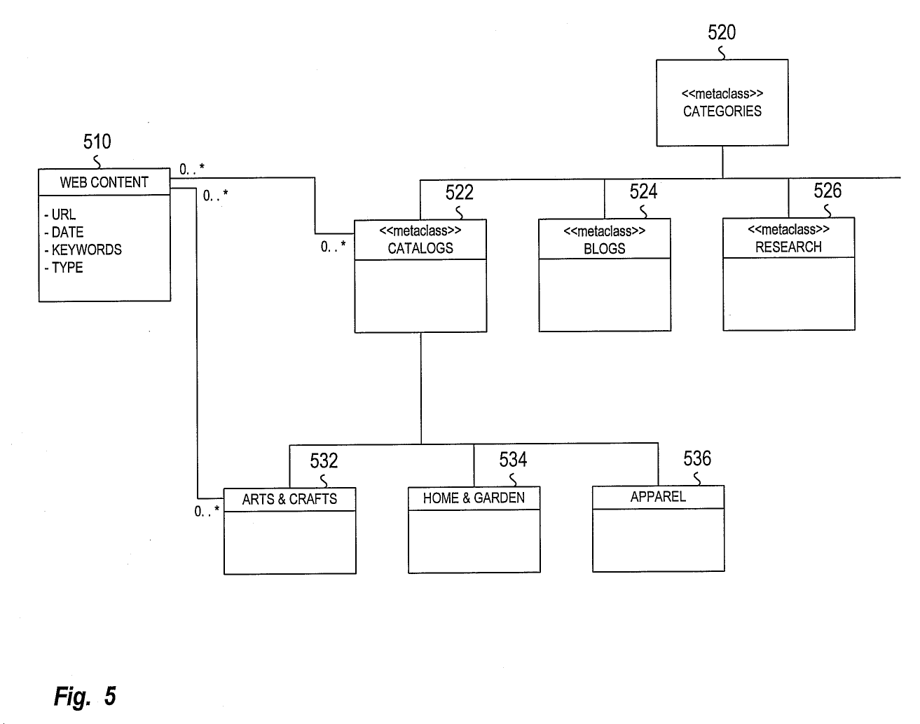

FIG. 5 is a class diagram for the graphical search engine in which web content 510 is stored with reference data corresponding to the URL, date, keywords, and type. Associations can be established both with categories as metaclasses (522, 524 and 526), as well as individual classes (e.g. Arts & Crafts under Catalogs depicted as items 532, 534 and 536, respectively). By establishing associations at different levels, it is possible to present the content associated with the metaclass (e.g. catalogs) or to tabulate it and list it as shown in FIG. 3B, where the number of items within the class of Arts & Crafts is shown, along with the individual listing (in this example this is shown in a horizontal format).

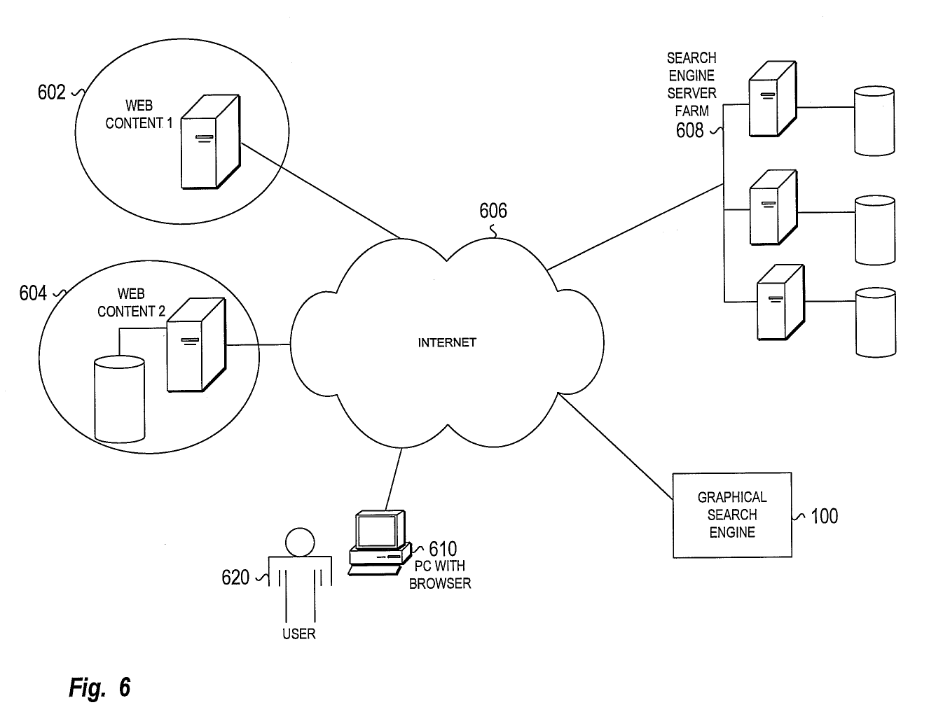

FIG. 6 shows exemplary architecture for the present invention in which web content (e.g., items 602 and 604) is accessed over the Internet 606 by the search engine server farm 608, which tabulates the accessed material and creates the search database which is accessed by the graphical search engine 100. The searcher (user 620) accesses the graphical search engine using a personal computer 610 with a browser, mobile computing device, or other network connected computing system. Although the embodiment represented in FIG. 6 is a centralized web server and search system, alternate embodiments are possible in which the searching and storage is distributed amongst a number of computers interconnected over the network. In yet another embodiment the graphical search engine is deployed in a local mode, wherein searching can be performed on the local PC for files and information stored on the PC. In this embodiment information regarding the content of the PC is presented in a graphical format to the user.

The embodiments of the present invention may be implemented with any combination of hardware and software. If implemented as a computer-implemented apparatus, the present invention is implemented using means for performing all of the steps and functions described above.

The embodiments of the present invention can be included in an article of manufacture (e.g., one or more computer program products) having, for instance, computer useable media. The media has embodied therein, for instance, computer readable program code means for providing and facilitating the mechanisms of the present invention. The article of manufacture can be included as part of a computer system or sold separately.

While specific embodiments have been described in detail in the foregoing detailed description and illustrated in the accompanying drawings, it will be appreciated by those skilled in the art that various modifications and alternatives to those details could be developed in light of the overall teachings of the disclosure and the broad inventive concepts thereof. It is understood, therefore, that the scope of the present invention is not limited to the particular examples and implementations disclosed herein, but is intended to cover modifications within the spirit and scope thereof.

I/We claim:

1. A method for presenting a graphical display of result materials obtained from a search query, the search query resulting in a number of hits; the method comprising:
visually depicting two or more categories, each category containing one or more hits; and
graphically indicating the number of hits within each category.

2. The method of claim 1 further comprising:
enabling a user to limit the search query to a specific type of content being searched, the types of content searched being selected from the group consisting of blogs, catalogs, images, audio, video, e-mails, and combinations thereof.

3. The method of claim 2 wherein the categories are selected from the group consisting of sites from which hits were obtained, categories related to the specific type of content searched, and combinations thereof.

4. The method of claim 3 wherein the sites are selected from the group consisting of Internet sites, intranet sites, mail server files, data on an individual user's computer, and combinations thereof.

5. The method of claim 2 further comprising providing a graphic user interface (GUI) to enable a user to view hits in a particular category.

6. The method of claim 2 wherein the depicted categories are blogs, the method further comprising identifying each depicted category by at least a portion of its domain name.

7. The method of claim 2 further comprising representing each depicted category as a vertical bar, the height of each bar indicating the number of hits in that category.

8. The method of claim 7 further comprising positioning each bar, relative to the other bars, based on its relative number of recent hits.

9. The method of claim 2 wherein the graphical display is a three-dimensional display, the method further comprising:
depicting each category along a first axis;
depicting the number of hits in each category along a second axis; and
utilizing a time dimension along a third axis to present periods of time in which hits occurred within each depicted category.

10. The method of claim 2 further comprising:
depicting each category as a horizontal timeline; and,
illustrating one or more hits in each category by a graphical marker on the timeline.

11. The method of claim 10 further comprising:
enabling a user to view hit details by hovering a cursor over a graphical marker.

12. The method of claim 10 wherein the timeline has a time scale, the method further comprising:
enabling a user to adjust the time scale.

13. The method of claim 2 wherein the depicted categories are selected from the group consisting of catalogs and games, the method further comprising:
representing each depicted category as a horizontal bar, the length of each bar indicating the number of hits in that category.

14. The method of claim 13 further comprising listing, adjacent to one or more of the horizontal bars, individual hits contained in the depicted category.

15. A system for presenting a graphical display of result materials obtained from a search query, the search query resulting in a number of hits; the system comprising:
a display device for visually depicting two or more categories, each category containing one or more hits; and wherein the number of hits within each category is graphically indicated.

16. The system of claim 15 further comprising:
an input device for enabling a user to limit the search query to a specific type of content being searched, the types of content searched being selected from the group consisting of blogs, catalogs, images, audio, video, e-mails, and combinations thereof.

17. The system of claim 16 further comprising:
a graphic user interface (GUI) to enable a user to view hits in a particular category.

18. The system of claim 16 wherein the display device:
depicts each category as a horizontal timeline; and,
illustrates one or more hits in each category by a graphical marker on the timeline.

19. The system of claim 18 further comprising:
an input device for enabling a user to view hit details by hovering a cursor over a graphical marker.

20. A data storage medium comprising indicia of instructions for a process to perform a method of presenting a graphical display of result materials obtained from a search query, the search query resulting in a number of hits; the method comprising:
visually depicting two or more categories, each category containing one or more hits; and
graphically indicating the number of hits within each category.

21. The data storage medium of claim 20 wherein the method further comprises:
enabling a user to limit the search query to a specific type of content being searched, the types of content searched being selected from the group consisting of blogs, catalogs, images, audio, video, e-mails, and combinations thereof.

22. The data storage medium of claim 21 wherein the method further comprises:
providing a graphic user interface (GUI) to enable a user to view hits in a particular category.

23. The data storage medium of claim 21 wherein the method further comprises:
depicting each category as a horizontal timeline; and,
illustrating one or more hits in each category by a graphical marker on the timeline.

24. The data storage medium of claim 23 wherein the method further comprises:
enabling a user to view hit details by hovering a cursor over a graphical marker.

25. The data storage medium of claim 21 wherein the depicted categories are selected from the group consisting of catalogs and games, the method further comprising:
representing each depicted category as a horizontal bar, the length of each bar indicating the number of hits in that category.
